(19) United States
(12) Patent Application Publication
(10) Pub. No.: US 2006/0101352 A1
(43) Pub. Date: May 11, 2006

(54) Rearranging views on a computer screen

(75) Inventors: Handoko Kohar, Eindhoven (NL); Jiska Margriet De Wit, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/541,990

(22) PCT Filed: Dec. 16, 2003
(86) PCT No.: PCT/IB03/06294

§ 371 Date: Jul. 11, 2005

(30) Foreign Application Priority Data
Jan. 14, 2003 (EP) 03100056.5

(51) Int. Cl. G06F 17/00

(52) U.S. Cl. 715/788

(57) ABSTRACT

On a computer screen (3), various non-overlapping views (A, B, C, . . . ) or “windows” may be displayed simultaneously. To present the views more conveniently for a user, the views can be automatically rear-ranged in response to a rearrangement request by the user. Various alternative arrangements can be presented in succession. It may be possible to exclude some views from being rearranged.

The present invention relates to rearranging views on a computer screen. More particularly, the present invention relates to a method of rearranging views on a computer screen, as well as to a computer in which the method is employed.

It is well known to present several views simultaneously on a computer screen. In Microsoft's Windows® operating system, for example, a new view or “window” is opened for every program activated by the user. The views allow a user to interact with the particular program or to read information presented in the view. Such views are also used in hand-held devices such as PDAs (Personal Digital Assistants) and palm-top computers.

Typically, when views are created, they are assigned both dimensions and a location on the screen of the computer. The user may alter the dimensions of the view to suit his needs and may also change its location. In this way, the appearance of the view may be adapted to the needs of the user. In particular, the user may wish to arrange the views in such a way that they do not overlap. This can be achieved relatively easily by reducing the dimensions of all views until they do not overlap, and then rearrange and/or resize them in any convenient manner. Alternatively, the user or the software manufacturer may program the views in such a way that certain preferred views, when activated, automatically appear in a convenient, non-overlapping arrangement.

The resulting arrangement of non-overlapping views may not be optimal for the user, or may not remain optimal. Depending on the various applications associated with the views, the user may wish to change their relative position during his computer session. In particular, the user may want to try which arrangement of views is most convenient. However, rearranging all views manually, for example by dragging with a mouse, is inconvenient and time-consuming.

Microsoft Windows® (versions 98 and XP) has an in-built feature called “windows tiling” which allows the active views to be automatically rearranged on the screen. This, however, involves re-sizing the views to fit them on the screen. The user, however, may not want the dimensions of the views to be changed. In addition, this known feature presents only a single arrangement of the views. If the user is not satisfied with this arrangement, any rearrangement of the views has to be carried out manually.

It is therefore an object of the present invention to overcome these and other problems of the prior art and to provide a method of rearranging views on a computer screen which is quick and simple to use.

It is another object of the present invention to provide a software product for rearranging views on a computer screen, and a record carrier provided with such a software product.

Accordingly, the present invention provides a method of rearranging non-overlapping views on a computer screen, the method comprising the steps of:

the computer receiving a rearrangement request from a user,

the computer determining an alternative arrangement of the views in response to the rearrangement request, and

the computer displaying the alternative arrangement on the screen.

That is, the computer automatically determines, upon receipt of a rearrangement request from the user, an alternative non-overlapping arrangement of the original views and displays this arrangement. If no alternative is available, the original arrangement is preferably displayed. Although it would be possible to resize the individual views, it is preferred that the views retain their original dimensions, that is, only their positions may be changed.

Preferably, in an alternative view, the positions of two views have been swapped relative to the original view. However, various other ways of rearranging the views can be envisaged, for example, rotating the positions of the views across the screen.

In a preferred embodiment, at least one view may be excluded from rearranging. That is, the user can select a view the position of which will not be changed when determining an alternative view. Selecting such a “frozen” view can be carried out, for example, by clicking on the view with a mouse, possibly using a special mouse button, or by clicking on a particular menu item associated with the view concerned.

Advantageously, the step of receiving a rearrangement request is carried out by the user activating a software button on the screen, for example, by clicking on such a button with a mouse or another suitable pointing device. Alternatively, a special key on the computer keyboard could be assigned for this purpose.

Although it is possible to determine a new alternative arrangement whenever a rearrangement request is received, it is preferred that all possible alternative rearrangements of the views are determined as the first rearrangement request is received, and that these alternative rearrangements are stored and successively displayed whenever a rearrangement request is received. When all possible alternative arrangements have been displayed, the original arrangement is displayed again. Optionally, a message could be displayed, stating that all possible arrangements have been displayed.

The present invention additionally provides a device, such as a computer, programmed to carry out the method defined above. The present invention further provides a software product for carrying out the method defined above, as well as a record carrier, such as a floppy disk, DVD or CD-ROM, provided with such a software product.

The present invention will be further explained below with reference to exemples of embodiments illustrated in the accompanying drawings, in which:

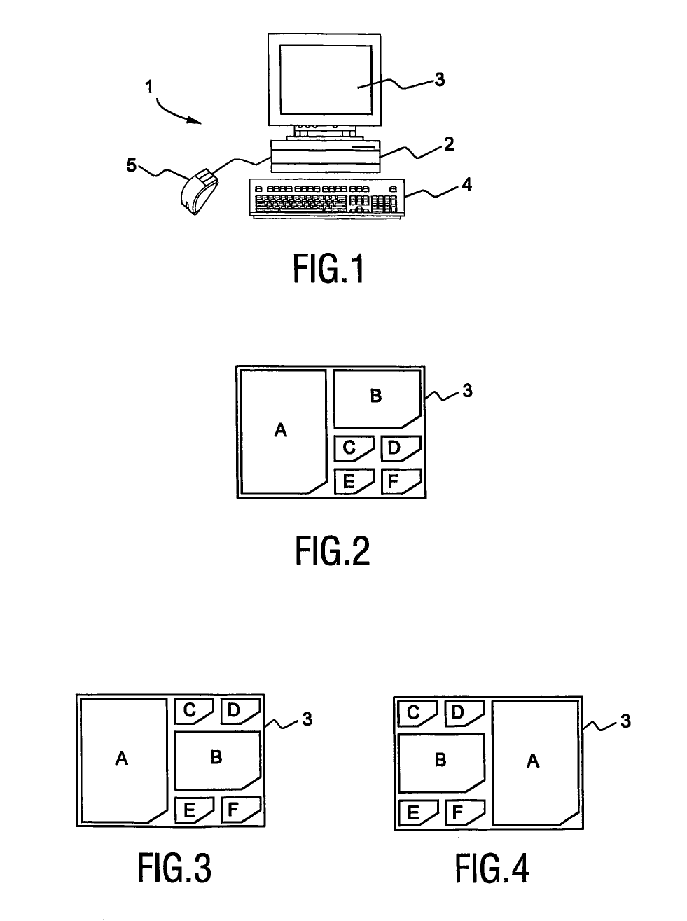

FIG. 1 schematically shows a computer system in which the present invention may be utilized.

FIG. 2 schematically shows a first arrangement of views on a computer screen.

FIG. 3 schematically shows a second arrangement of views on a computer screen.

FIG. 4 schematically shows a third arrangement of views on a computer screen.

The computer system 1 shown merely by way of non-limiting example in FIG. 1 comprises a computer unit 2 connected to a display screen 3 and a keyboard 4. The computer unit 2 executes various software programs, including an operating system having a graphical user interface such as Microsoft Windows® or operating systems marketed by Apple Computer Inc. The computer unit 2 also executes a software program for carrying out the method of the present invention, as well as several other software programs.

Several views are displayed on the screen 3 of the computer system 1, each view corresponding to an active software program. FIG. 2 schematically shows, by way of example only, an original arrangement of the views, as arranged by the operating system or by the user on a screen. A first view A is approximately half the size of the screen (3 in FIG. 1), while a second view B is approximately a quarter of the size of the screen. Views C, D, E and F are each one-sixteenth the size of the screen. It will be understood that these dimensions are given by way of example only and that, in principle, the views could have any dimensions which would allow them to fit on the screen and to avoid overlap.

The user may decide that the view of FIG. 2 is not ideal and may wish to change the view. Instead of manually dragging the individual views to other locations on the screen using a mouse, touch pad or other pointing device, while avoiding overlap, the present invention allows the computer to present various alternative arrangements of views from which the user can select the most suitable arrangement.

Accordingly, the user may activate a rearrangement button (not shown) on the screen or issue a rearrangement request in any other suitable manner, for example, by pressing a particular key on the keyboard (4 in FIG. 1). In response to this rearrangement request, the software program being executed by the computer determines a number of alternative arrangements. In a preferred embodiment, all possible arrangements are determined and stored for later use, although it is possible to determine only a single alternative arrangement, or only a limited number such as two or three, each time the rearrangement request is received.

One such possible rearrangement is shown in FIG. 3, where views C and D have been moved from below view B to above view B. A further possible rearrangement is shown in FIG. 4 where view A has been shifted from the left half of the screen to the right half of the screen, the other views having been rearranged accordingly.

As mentioned above, the various alternative views are presented to the user. In a preferred embodiment, a single alternative arrangement is presented when producing a rearrangement request (for example, by clicking on a “rearrange” button), subsequent requests each presenting another single arrangement. After presenting all available arrangements, the original arrangement is presented again. It is, however, also possible to present all alternative views in succession, with intervals of several seconds, allowing the user to select a particular view by another user action, for example, by again clicking on the above-mentioned “rearrange” button.

In a preferred embodiment of the present invention, it is possible to “freeze” one or more views within an arrangement, that is, to exclude these views from the rearrangement process. The user may select these excluded or “frozen” views, for example, by clicking on a dedicated button in each view, or by selecting these views from a list presented by the software program when issuing a rearrangement request. The particular algorithm will then attempt to present alternative views while maintaining the positions of the “frozen” views. When no alternative arrangement is possible, the original arrangement will be maintained and an optional error message may be issued.

Determining the alternative arrangements that are possible, given a certain set of non-overlapping views having given dimensions, can be carried out in a number of ways. The actual algorithm employed is not essential to the present invention. However, some examples will be given to further illustrate the application of the present invention.

The alternative views could be determined by first swapping the positions of the two smallest views having compatible dimensions, and subsequently swapping the positions of larger views. In the example of FIG. 2, views C and D could take each other's positions, thus providing a first alternative arrangement (AA). Subsequently, the positions of views E and F could be swapped, thus generating a second AA. As views C and E, and D and F, respectively, have approximately the same dimensions, views C and E could trade places, followed by D and F, thus producing two more alternative arrangements. In a subsequent step, the position of view B could be exchanged with that of views C through F. In addition to swaps, shifts could be considered, for example, shifting a view and fitting other views in the resulting gap. It will be clear that by considering both “horizontal” and “vertical” swaps and shifts, while taking the relative dimensions of the views into account, all possible alternative view arrangements can be produced.

Although the smallest views were swapped first in the example above, it may be advantageous to start with the largest views, as repositioning the latter will have the greatest impact. It can also be envisaged that the user can choose between various algorithms, and that he can choose, for example, whether to swap large or small views first.

Instead of the “swapping algorithm” outlined above, various other algorithms could be used, for instance, a “random shuffle” algorithm which randomly attempts to fit all views concerned into the screen while avoiding overlap. Alternatively, or additionally, mirror imaging of the screen arrangement may be utilized to produce alternative views.

The arrangement ultimately selected by the user may be stored and the software program may automatically generate the selected arrangement the next time the user logs into the computer system.

A software program for carrying out the method of the present invention may be a separate utility program or may be integrated in the operating system. The software program may be stored on a machine-readable record carrier, such as a floppy disk, a CD-ROM, a zip-disk, a DVD and the like.

The present invention is based upon the insight that views displayed on a computer screen may be rearranged by the computer so as to produce an alternative arrangement. The present invention benefits from the further insight that a user may be presented several alternative arrangements of views, from which the user may select the most suitable arrangement.

It is noted that any terms used in this document should not be construed so as to limit the scope of the present invention. In particular, use of the verbs “comprise” and its conjugations is not meant to exclude any elements not specifically stated. Single (circuit) elements may be substituted for multiple (circuit) elements or their equivalents. In addition, the word “computer” as used in this document is not limited to desktop computers but is also meant to encompass laptop computers, palmtop computers, PDAs, electronic organizers and other electronic devices comprising a screen and a processor.

It will therefore be understood by those skilled in the art that the present invention is not limited to the embodiments illustrated above and that many modifications and additions may be made without departing from the scope of the invention as defined in the appending claims.

1. A method of rearranging non-overlapping views (A, B, C, . . . ) on a computer screen (3), the method comprising the steps of:
the computer receiving a rearrangement request from a user,
the computer determining an alternative arrangement of the views in response to the rearrangement request, and
the computer displaying the alternative arrangement on the screen.

2. The method as claimed in claim 1, wherein the views retain their original dimensions.

3. The method as claimed in 1, wherein, in an alternative view, the positions of two views have been swapped relative to the original view.

4. The method according to claim 1, wherein at least one view may be excluded from rearranging.

5. The method according to claim 1, wherein the step of receiving a rearrangement request is carried out by the user activating a software button on the screen.

6. The method according to claim 1, wherein all possible alternative rearrangements of the views are determined as the first rearrangement request is received, these alternative rearrangements being stored and successively displayed whenever a rearrangement request is received.

7. The method according to claim 1, wherein, when all possible alternative arrangements have been displayed, the original arrangement is displayed again, preferably a message being displayed stating that all possible arrangements have been displayed.

8. A device programmed to carry out the method according to claim 1, which device preferably is a desktop computer, a laptop computer, a palmtop computer, a PDA or an electronic organizer.

9. A software product for carrying out the method according to claim 1.

10. A record carrier, such as a CD-ROM, provided with a software product as claimed in 9.
